(19) United States
(12) Patent Application Publication
(10) Pub. No.: US 2026/0317169 A1
(43) Pub. Date: Oct. 15, 2026

(54) HYDROGEN GENERATION BY REFORMING AND OXYCOMBUSTION

(71) Applicant: EXXONMOBIL TECHNOLOGY AND ENGINEERING COMPANY, Spring, TX (US)

(72) Inventors: Everett J. O'NEAL, Spring, TX (US); Lu HAN, Ringoes, NJ (US); Shelby G. LUX, Maplewood, NJ (US); David C. DANKWORTH, Princeton, NJ (US)

(21) Appl. No.: 19/636,611

(22) Filed: Apr. 1, 2026

Related U.S. Application Data
(60) Provisional application No. 63/785,884, filed on Apr. 9, 2025.

(51) Int. Cl. C01B 3/40; C01B 3/382

(52) U.S. Cl. CPC C01B 3/40; C01B 3/382; C01B 2203/0227; C01B 2203/0827; C01B 2203/1058; C01B 2203/1241; C01B 2203/1258; C01B 2203/1276; C01B 2203/168

(57) ABSTRACT

Systems and methods are provided for performing reforming in the presence of a nickel-containing catalyst. The heating flow is formed by performing oxycombustion within the reactor. However, degradation of the nickel-containing catalyst is reduced or minimized by keeping the heating flow and the reforming flow in separate volumes. In particular, the combustion products of the heating flow are maintained in a separate volume from the reforming flow channels that contain the nickel-containing reforming catalyst. Additionally, in order to provide improved thermal efficiency, the systems and methods are configured so that the hottest portion of the reactor is toward a middle portion of the reactor, with both ends of the reactor being colder than a middle portion. This is achieved while performing reforming in a continuous manner.

### CROSS-REFERENCE TO RELATED APPLICATION

This Non-Provisional Patent application claims priority to U.S. Provisional Patent Application No. 63/785,884, filed Apr. 9, 2025, and titled “Hydrogen Generation By Reforming And Oxycombustion”, the entire contents of which is incorporated herein by reference.

### FIELD OF THE INVENTION

Systems and methods are provided for hydrogen generation using oxycombustion in a counter-current reactor.

### BACKGROUND OF THE INVENTION

Steam reforming is a commonly used technique for converting methane or other hydrocarbons into hydrogen and carbon oxides. One option for performing steam reforming is to use a counter-current configuration with discrete or separated flows. One flow corresponds to a flow for performing steam reforming. A second flow corresponds to a heat transfer flow that is kept separate from the volume(s) where the steam reforming is performed. Conventionally, the flows are typically arranged in a counter-current manner so that the hottest part of the heat transfer flow, at one end of the reactor, corresponds to the location where the highest reforming temperatures are provided.

Another conventional configuration for performing reforming is to use a shell-and-tube reactor. A shell-and-tube reactor has an exterior shell with tubes inside the shell. The volume within the shell that is outside of the tubes is not in direct fluid communication with the volume inside of the tubes. This allows flows to be separated, so that heat management can be performed in one volume, such as the shell volume, while a separate reaction is maintained in a second volume, such as within the tubes.

U.S. Pat. No. 11,511,992 describes using oxycombustion for providing heat to a reverse flow reactor, such as during reforming.

U.S. Patent Application Publication 2024/0109775 describes hydrogen generation in a high temperature counter-current reactor.

U.S. Pat. No. 11,691,874 describes a counter-current shell-and-tube reactor for hydrogen production via reforming. Heat is provided to the reactor by a hot flue gas that is formed in a separate combustor. The hot flue gas flows through the reactor, with the heated gas entering on one end of the reactor and exiting from the opposite end. The reforming reaction takes place within the tubes.

U.S. Pat. No. 8,168,131 describes a low pressure drop reforming reactor. The reforming reactor corresponds to a counter-current reactor. In order to allow for at least partial recovery of heat from the reforming products, after the products exit from the reforming reaction volume, the reforming products are mixed with the heating flow that is passed in a counter-current manner around the reforming reaction volume.

U.S. Pat. No. 7,918,906 describes a partial oxidation reforming reactor with a linear countercurrent heat exchanger. An outer volume of the reactor corresponds to a boiling water heat exchanger. Heat is provided for the reactor by combusting a first portion of a reactant flow. The partially combusted reactant flow is then used as the feed for reforming.

U.S. Pat. No. 7,094,363 describes a process for the preparation of synthesis gas.

U.S. Pat. No. 7,744,664 describes a compact counterflow fuel reformer.

U.S. Pat. Nos. 7,815,873 and 8,754,276 provide examples of using reverse flow reactors to perform various endothermic processes in a cyclic reaction environment. Reverse flow reactors are an example of a reactor type that is beneficial for use in processes with cyclic reaction conditions. For example, due to the endothermic nature of reforming reactions, additional heat needs to be introduced on a consistent basis into the reforming reaction environment. Reverse flow reactors can provide an efficient way to introduce heat into the reaction environment. After a portion of the reaction cycle used for reforming or another endothermic reaction, a second portion of the reaction cycle can be used for combustion or another exothermic reaction to add heat to the reaction environment in preparation for the next reforming step.

### SUMMARY OF THE INVENTION

In an embodiment, a method for performing reforming under substantially counter-current flow conditions is provided. The method is performed in a reaction system that includes a first reactor zone, a mixing zone, and a reforming zone. The method includes passing a fuel into a fuel flow path and an oxygen-containing gas into an oxidant flow path in the first reactor zone. The oxygen-containing gas can contain 15 vol % or less of N₂ relative to a volume of the oxygen-containing gas. The method further includes passing a reforming input flow containing at least one hydrocarbon into a plurality of reforming flow channels in the reforming zone, at least a portion of the reforming flow channels having a reforming catalyst containing Ni in the reforming zone. The method further includes mixing the fuel, the oxygen-containing gas, and a recycle stream containing H₂ and CO₂ in one or more heating flow volumes within a mixing zone to form a fuel mixture containing 20 vol % or more of CO₂ relative to a volume of the fuel mixture, the mixing zone being adjacent to the first zone, an opposing side of the mixing zone being adjacent to the reforming zone. The method further includes combusting the fuel mixture in the one or more heating flow volumes in at least one of the mixing zone and the reforming zone to generate heat and a combustion product flow, the one or more heating flow volumes being arranged around the plurality of reforming flow channels in the mixing zone and the reforming zone. A direction of flow for the reforming input flow in the portion of the reforming channels containing the reforming catalyst can be substantially counter-current to a direction of flow for the combustion product flow. The method further includes reforming at least a portion of the at least one hydrocarbon in the reforming channels under reforming conditions in the presence of the reforming catalyst to form a reforming product flow. A peak temperature in the reforming flow channels can be greater than a temperature in the reforming flow channels at an end of the reforming zone farthest from the mixing zone by 100 °C or more. The method further includes separating the combustion product flow to form a CO₂-containing product stream and a first recycle portion. Additionally, the method includes separating the reforming product flow to form an H₂-containing product stream containing 80 vol % or more of H₂ and second recycle portion containing H₂, wherein the recycle stream comprises the first recycle portion and the second recycle portion, wherein the reforming input flow and the reforming product flow are not mixed with the fuel, the oxygen-containing gas, and the oxidized product flow within the reforming flow channels, and optionally wherein the first zone, the mixing zone, and the reforming zone are part of a single reactor volume.

In other embodiments, a reforming reaction system is provided. The reaction system includes a reactor having a reactor volume that includes a first zone, one or more mixing elements in a mixing zone, a reforming zone, one or more reforming flow channels, and one or more heating flow volumes. At least a portion of the one or more reforming flow channels can reside in the reforming zone and have a reforming catalyst that contains Ni. The mixing zone can be adjacent to the first zone, an opposing side of the mixing zone being adjacent to the reforming zone. The one or more second flow channels can being arranged around the one or more reforming flow channels. The first zone can include at least an oxidant flow path and a fuel flow path, at least one of the fuel flow path and the oxidant flow path providing fluid communication between an end of the first zone and the mixing zone without providing fluid communication between the oxidant flow path and the fuel flow path in the first zone. The reaction system further includes a first separation stage having a first separation inlet in fluid communication with the one or more heating flow volumes and a plurality of first separation outlets, at least one first separation outlet in fluid communication with the oxidant flow path. The reaction system further includes a second separation stage having a second separation inlet in fluid communication with the one or more reforming channels and a plurality of second separation outlets, at least one second separation outlet in fluid communication with the fuel flow path. Optionally but preferably, the one or more reforming flow channels and the one or more heating flow volumes do not have direct fluid communication within the reactor volume.

### BRIEF DESCRIPTION OF THE DRAWINGS

FIG. 1 shows an example of a reaction system for performing reforming using a counter-current reactor.

FIG. 2 shows an example of a reactor having separate reforming flow channels and heating flow volumes.

FIG. 3 shows an example of a reactor having separate reforming flow channels and heating flow volumes where combustion is performed in a heating flow volume that is offset from the reforming flow channels.

FIG. 4 shows an example of a configuration for mixing a fuel flow and an oxygen-containing flow at a mixing element.

FIG. 5 shows an example of a reactor with mixing elements at multiple locations to provide an expanded region for combustion.

FIG. 6 shows an example of another reactor configuration having separate reforming flow channels and heating flow volumes.

### DETAILED DESCRIPTION OF THE EMBODIMENTS

All numerical values within the detailed description and the claims herein are modified by “about” or “approximately” the indicated value, and take into account experimental error and variations that would be expected by a person having ordinary skill in the art.

### Overview

In various embodiments, systems and methods are provided for performing reforming in the presence of a nickel-containing catalyst. The heating flow is formed by performing oxycombustion within the reactor. However, degradation of the nickel-containing catalyst is reduced or minimized by keeping the heating flow and the reforming flow in separate volumes. In particular, the combustion products of the heating flow are maintained in a separate volume from the reforming flow channels that contain the nickel-containing reforming catalyst. Additionally, in order to provide improved thermal efficiency, the systems and methods are configured so that the hottest portion of the reactor is toward a middle portion of the reactor, with both ends of the reactor being colder than a middle portion. This is achieved while performing reforming in a continuous manner.

Systems and methods are also provided for forming the heating flow using oxycombustion, so that a relatively high purity oxygen stream is used as the oxygen source for the combustion reaction that provides the heating flow. By using oxycombustion, the resulting flue gas can have a relatively high content of CO₂ and H₂O while having a relatively low content of N₂ and/or other components. This can facilitate purification of the CO₂ in the flue gas, so that the CO₂ can then be used and/or sequestered. Further benefits can be achieved based on recycle of waste streams generated during recovery of CO₂ from the flue gas and during recovery of H₂ from the reforming effluent.

A variety of reactor configurations are conventionally known for reforming of hydrocarbons. One category of conventional configurations are configurations designed to provide continuous operation of a reactor while operating in a counter-current manner. Heat is added to the reactor from one end in a first volume within the reactor, while reactants are introduced into a second, separate volume in the reactor from the opposite end. While this simplifies the configuration, such conventional configurations typically have a “hot” end and a “cold” end. Because the highest temperatures for reaction are also located at the end of the reactor, the ability to recover heat is constrained, as the products exiting from the reactor are at the “hot” temperature. This reduces efficiency, as a substantial portion of the heat added to the reactor simply exits from the reactor with the product stream. While heat recovery can be performed on the reactants after exiting from the reactor, it would be preferable and more efficient to be able to increase the use of the heat that is introduced into the reactor.

In various embodiments, the above difficulties with heat recovery during a continuous reforming process can be reduced or minimized by using a reactor configuration that operates so that the highest temperatures in the reactor are in a middle portion of the reactor. This heat profile is achieved by performing combustion within the middle portion of the reactor to provide the heat. The location of combustion is controlled by maintaining separate flows for the fuel and oxidant for combustion until a target location within the reactor. The fuel and oxidant are then mixed to allow combustion to occur. The flow of the combustion gases carries the heat generated by the combustion further into the reactor, resulting in a heat bubble within the reactor that corresponds to the highest temperatures within the reactor. The reforming zone within the reactor corresponds to this middle region (or heat bubble) where the highest temperatures are present.

Performing combustion within a middle portion of the reactor provides a variety of advantages. First, all of the heat of combustion is initially generated within the reaction zone. This avoids losses of heat to the environment during transport of the heated combustion products into the reactor. Second, by initiating the combustion reaction within a middle portion of the reactor, both ends of the reactor can be used for heat exchange to increase the temperature of either the incoming fuel and oxidant or the incoming reforming reactants. This further reduces or minimizes the loss of heat to locations outside of the reactor.

Further advantages can be achieved when the combustion performed within the reactor corresponds to oxycombustion, where the source of oxygen for the combustion reaction is enriched in oxygen relative to air. By using an oxygen source with a reduced or minimized content of N₂, the resulting combustion products can be enriched in CO₂ and H₂O. Water is readily separated from carbon dioxide, which can allow the combustion products to be separated to form a high purity CO₂ stream for further use and/or sequestration.

In order to achieve the above advantages, a reforming reactor can be used that allows a temperature profile to be maintained where the hottest temperatures in the reactor are toward a middle portion of the reactor. For example, the reactor can have one set of channels or tubes that contain the reforming catalyst and provide the volume for performing the reforming reaction. These tubes are within a larger shell or vessel where the combustion is performed. In addition to the channels or tubes for the reforming reactants and products, an additional set of conduits or channels can be present to allow the oxygen-containing flow to remain separate from the fuel flow when the fuel and oxygen first enter the reactor. By maintaining the oxygen-containing flow and the fuel flow as separate flows until the flows reach a target location within the reactor, the location of combustion can be controlled. This enables the formation of the heat bubble within the middle portion of the reactor, so that a middle portion of the reactor is hotter than both ends of the reactor.

In the discussion below, combustion and reforming reactions will be described as being performed in a reactor that includes several zones. It is understood that in alternative embodiments, the several zones can be placed in a plurality of reactors, so that at least one zone may be in a different reactor from at least one other zone. Unless otherwise specified, it is understood that any description below related to a single reactor can also be performed in a plurality of reactors.

As an example of an alternative embodiment, combustion can be performed in a first combustion vessel to generate a flue gas. The resulting hot flue gas can then be passed into a middle portion of a reforming reactor to provide heat for the reforming reaction. Optionally, this alternative configuration can be used in some embodiments where the combustion reaction is performed at a relatively high pressure.

### Reaction System Configuration Overview

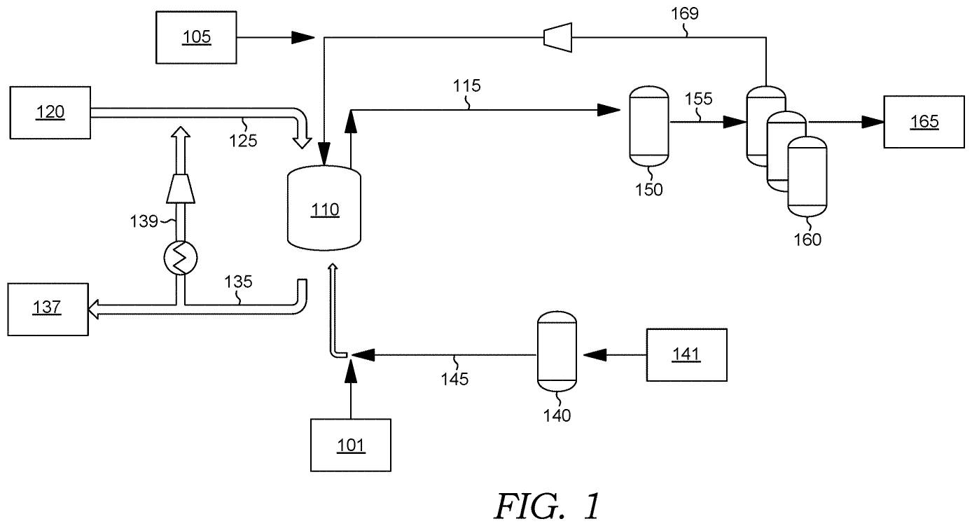

FIG. 1 provides an overview of a process configuration for performing reforming with heating provided by oxycombustion. In FIG. 1, reactor 110 can correspond to a single reactor that includes multiple zones or volumes, or reactor 110 can correspond to a plurality of reactors, so that at least one zone is located in a separate reactor from at least one other zone. The zones within the reactor(s) 110 can include a reforming zone, a mixing zone, and a zone that fuel and oxidant are initially passed into prior to reaching the mixing zone. This latter zone can be referred to as a first zone or a recuperation zone, depending on the aspect.

In the configuration shown in FIG. 1, one set of inputs to reactor 110 is for performing a heating/combustion reaction. Air separation unit 120 generates an oxygen-containing stream 125 that has a reduced or minimized content of nitrogen. In some alternative embodiments, any other convenient method can be used to form an oxygen-containing stream 125 with an oxygen content of greater than 30 vol % and/or an N₂ content of less than 50 vol %. Optionally, an additional recycle stream 139 containing CO₂ and H₂O can also be introduced to the oxidant flow paths in reactor 110, either as a mixture with oxygen-containing stream 125 or separately.

A fuel is also introduced into reactor 110. A portion of the fuel corresponds to supplemental fuel 105, such as supplemental natural gas. Another portion of the fuel is a recycled tail gas stream 169 that contains various components, including CO₂, CO, and H₂. The supplemental fuel 105 and recycled tail gas stream can be combined prior to entering reactor 110, or the two fuel portions can enter reactor 110 separately.

The fuel and oxygen-containing stream are mixed within reactor 110 and then combusted to provide heat for the reforming reaction. This results in production of a flue gas 135 that contains the combustion products of CO₂, H₂O, and any diluent gases (such as N₂) that may have been present in the either the fuel flow or the oxygen-containing flow. The flue gas 135 is separated to form a CO₂ product stream 139 and a recycle stream 137 that primarily includes any CO₂ not in the product stream 139, as well as the majority of any other components that were in flue gas 135. The recycle stream 137 subjected to heat exchange and/or compression so that the recycle stream is suitable for addition to the oxygen-containing flow 125 and/or for additional directly into reactor 110. The recycle stream 137 adds CO₂ and H₂O that can serve as heat transport gases for carrying the heat generated during combustion from the combustion location to other portions of the heat transfer volumes in the reactor.

Components for performing a reforming reaction are also introduced into reactor(s) 110. The reagents for the reforming reaction are introduced into separate reforming channels within the reactor 110. Steam 101 and a hydrocarbon feed 141 (such as natural gas) are introduced into reactor 110. Optionally, the hydrocarbon feed 141 can be passed through a pre-reformer 140 to produce a partially reformed feed 145. In such optional embodiments, the partially reformed feed 145 still includes some natural gas but also includes hydrogen generated during the pre-reforming stage. The steam and hydrocarbons are reacted in reactor 110 to generate a reforming effluent 115 that includes at least CO₂, CO, H₂O, and H₂. The reforming effluent 115 is optionally passed through an additional water gas shift stage 150 to modify the composition of the reforming effluent, such as by increasing the H₂ content of the reforming effluent. The optionally shifted reforming effluent 155 is then separated 160 to form a hydrogen-containing product 165 and a tail gas 169.

It is noted that in FIG. 1, reactor 110 is in direct fluid communication with water gas shift stage 150, while reactor 110 is in indirect fluid communication with separation stage(s) 160. The indirect fluid communication between reactor 110 and separation stage(s) 160 is via water gas shift stage. More generally, direct fluid communication refers to fluid communication between process elements without passing through an intervening process element, while indirect fluid communication occurs when a flow passes through an intervening process element to get from one location to another location.

### Recycle and Oxycombustion

One of the challenges in operating a reactor where the peak temperature in the reactor is at a middle location in the reactor, as opposed to an end of the reactor, is managing the introduction of heat. Generally, the amount of heat that can be introduced is constrained by the need to avoid excessive temperature spikes in localized areas. For example, performing too much combustion at a single location could result in exceeding a maximum temperature for the structural materials and/or internal components of the reactor.

In order to overcome this difficulty, a working fluid can be introduced as part of the fuel mixture. The heating flow volumes can optionally also be pressurized during regeneration to increase the amount of working fluid per unit volume. The working fluid absorbs a portion of the heat generated during combustion and carries the heat to downstream locations within the heating flow volumes (relative to the direction of flow of the combustion products). This can allow additional heat to be introduced into the heating flow volumes while reducing the maximum temperature at any location. Thus, the input flows for combustion can correspond to a combination of fuel, an oxygen-containing stream, and a working fluid. In various embodiments, one or more of the fuel, the oxygen-containing stream, and the working fluid can be modified to allow for production of a flue gas that corresponds to a high pressure CO₂-containing gas. In various embodiments, the working fluid for the combustion process can include a recycled portion of the flue gas generated by the combustion process. Additionally, a portion of the fuel used for combustion can be a recycled tail gas generated during separation of hydrogen from the reforming products. In addition to containing fuel components such as unreformed hydrocarbons and some hydrogen, the separation tail gas can include additional CO₂ and H₂O while having little or no N₂ content.

Conventionally, combustion reactions typically use air as an oxygen source. Air includes a substantial amount of N₂, which is a relatively low heat capacity gas. Even if some recycled flue gas is also used as a working fluid for heat transport, if air is used as the oxygen source for combustion, nitrogen can correspond to 50 vol % or more of the total input gas flows for combustion. As a result, conventionally, the volume of nitrogen can potentially be as much as an order of magnitude greater (or more) than the amount fuel that is introduced to generate heat (volume basis). This large volume of working fluid can result in substantial pressure drops within a reactor, leading to substantial operating costs for compression. Larger reactor sizes (or larger heating flow volumes within a reactor) could mitigate the pressure drops, but such increases in reactor size can create other processing difficulties. Additionally, increasing reactor footprint within a refinery is typically a less desirable outcome.

Instead of using air as the oxygen source for combustion, in various embodiments the oxygen source for combustion can correspond to an oxygen-containing stream that contains substantially less nitrogen than air and/or more oxygen than air. For example, an oxygen-containing stream can be used that contains 30 vol % or more of oxygen, or 50 vol % or more, or 70 vol % or more, such as up to 100 vol % of oxygen. Additionally or alternately, the nitrogen content of the oxygen-containing stream can be 30 vol % or less, or 15 vol % or less, or 10 vol % or less, or 1.0 vol % or less, such as down to having substantially no nitrogen content (0.1 vol % or less). An air separation unit can generate oxygen-containing streams that have elevated oxygen contents and/or reduced nitrogen contents.

Reducing the amount of nitrogen present in the combustion environment results in a corresponding reduction in the amount of nitrogen in the flue gas. As a result, a second modification of the heating process can be to use a working fluid that contains a reduced or minimized amount of nitrogen.

Because the working fluid corresponds at least in part to recycled flue gas, the combustion products from previous cycles are included in the working fluid. This means that the working fluid can include both CO₂ and H₂O. In various embodiments, the working fluid can include 20 vol % or more CO₂, or 25 vol % or more, or 30 vol % or more, or 40 vol % or more, such as up to 100 vol %. In some embodiments, the working fluid can include 20 vol % to 60 vol % CO₂, or 25 vol % to 60 vol %, or 30 vol % to 60 vol %, or 20 vol % to 50 vol %, or 25 vol % to 70 vol %. Optionally, the working fluid can include 10 vol % or more of H₂O, or 20 vol % or more, or 40 vol % or more, such as up to 70 vol % or possibly still higher. If desired, a water separation step could be included as part of a flue gas recycle loop to reduce the amount of H₂O in a working fluid. In some embodiments, the working fluid can include 95 vol % to 100 vol % of CO₂ and H₂O, or 98 vol % to 100 vol %. It is noted that if the working fluid corresponded entirely to the combustion products formed from stoichiometric combustion of methane, the working fluid would have a composition of roughly 33 vol % CO₂ and 67 vol % H₂O. Depending on the aspect, the working fluid can contain 15 vol % or less of N₂, or 10 vol % or less, or 5 vol % or less, or 2.0 vol % or less, such as down to having substantially no N₂ content (0.1 vol % or less). This is in contrast to a conventional configuration for reforming of hydrocarbons in a reverse flow reactor, where 40 vol % or more of the working fluid can correspond to N₂.

In some embodiments, the fuel for the regeneration step can correspond to a conventional hydrocarbon fuel, such as methane or natural gas. In other embodiments, the fuel can correspond to a mixture of a hydrocarbon fuel (such as methane) and a recycled tail gas from separation of the reforming effluent. When a recycled tail gas is included as part of the fuel, the resulting fuel mixture (fuel plus working fluid plus oxygen-containing gas) can include 2.0 vol % or more of CO, or 5.0 vol % or more, or 8.0 vol % or more, such as up to 15 vol % or possibly still higher. A tail gas for recycle can be formed, for example, by separating hydrogen from the reforming effluent using a swing adsorber.

Reducing or minimizing the nitrogen content of the input flows for the combustion process can facilitate performing combustion at a substantially higher pressure. Conventionally, combustion for providing heat within a reactor would be performed at a pressure near ambient. With a conventional recycled flue gas containing substantial amounts of N₂, operating the regeneration at higher pressures would require an undesirable increase in compression costs. This is due to the large volumes of N₂ that are needed to compensate for the low heat capacity of N₂. In contrast to conventional operation, in various embodiments the combustion can be performed using combustion conditions corresponding to a pressure of 0.5 MPa−g to 7.0 MPa−g, or 0.7 MPa−g to 7.0 MPa−g, or 1.4 MPa−g to 7.0 MPa−g, or 3.4 MPa−g to 7.0 MPa−g. In other embodiments, higher pressure combustion conditions can be used, such as a combustion pressure of 0.7 MPa−g to 15 MPa−g, or 1.4 MPa−g to 15 MPa−g, or preferably 3.4 MPa−g to 15 MPa−g, or more preferably 7.5 MPa−g to 15 MPa−g.

Operating at higher pressure combustion conditions can provide several advantages. First, higher pressure operation can facilitate heat transfer within the reverse flow reactor, resulting in a more evenly distributed heat profile after regeneration. Second, by forming a higher pressure flue gas that contains primarily CO₂ and H₂O, a portion of the flue gas can be used as a CO₂ stream for sequestration or other uses after minimal additional processing.

After passing through the reactor, a portion of the flue gas can be compressed to return the flue gas to the pressure for use as a working fluid during combustion. Before or after compression, a portion of the flue gas can be separated out as a CO₂-containing product stream. The water in the CO₂-containing product stream can be removed by cooling the CO₂-containing product stream, such as by heat exchange. In continuous flow operation, this can be performed while roughly maintaining the pressure of the CO₂-containing stream. This can result in a CO₂-containing stream with a CO₂ content of 80 vol % or more, or 90 vol % or more, or 95 vol % or more, such as up to containing substantially only CO₂ (less than 0.1 vol % of other components, or 99.9% or more CO₂). The CO₂-containing stream can then be passed into a sequestration process. Alternatively, the CO₂-containing stream can be used as an input for a process that uses CO₂, such as dry ice production or injection into a hydrocarbon extraction site. Generally, sequestration and/or use of CO₂ is performed at a pressure of roughly 7.0 MPa−g or more, or 14 MPa−g or more, such as up 20 MPa−g or possibly still higher.

In addition to the above advantages, it has been discovered that using a higher heat capacity gas as the diluent during combustion can provide an unexpected decrease in the laminar flame speed of the combustion reaction at temperatures of 600 °C or more. A higher laminar flame speed corresponds to faster combustion. Decreasing the laminar flame speed of the combustion reaction can expand the distance within the reactor where the combustion reaction occurs. This spreading out of the combustion region can provide a further unexpected reduction in maximum temperature when combustion is performed at temperatures of 600 °C or more, or 700 °C or more, or 800 °C or more, such as up to 1500 °C or possibly still higher. In some embodiments, addition of a high heat capacity gas to the diluent can reduce the laminar flame speed at temperature of 600 °C or more, or 700 °C or more, or 800 °C or more, to 100 cm/s or less, or 75 cm/s or less. It is noted that the decrease in laminar flame speed may be due in part to improved radical quenching by the higher heat capacity gas.

### Configuration Examples—Heating Flow Volumes and Reforming Channels

In various embodiments, the combustion reactions and reforming reactions within the reactor(s) are performed in separate volumes within the reactor(s). The reforming reactions are performed within reforming channels, such as tubes that include reforming catalyst within at least a portion of the tube. The reactants for reforming are introduced into the reforming channels in the reforming zone of the reactor. Depending on the configuration, the resulting reforming effluent can exit from the reforming zone of the reactor, or from the opposite end of the reactor, which can be referred to as a first zone or a recuperation zone. The combustion reactions are performed in heating flow volumes. Fuel for combustion and an oxygen-containing flow are introduced into the first zone or recuperation zone of the reactor. The fuel and oxygen-containing flow are maintained in separate volumes until the fuel and oxygen-containing flow arrive at a mixing zone. In some configurations, the mixing zone is located between the first zone and the recuperation zone, with one end of the mixing zone being adjacent to the first zone and an opposite end of the mixing zone being adjacent to the reforming zone. In other embodiments, the mixing zone can be offset from the reforming zone. The fuel can be introduced into fuel flow channels while the oxygen-containing flow is introduced into oxidant flow channels. It is noted that in some aspects, either the “fuel flow channels” or the “oxidant flow channels” may simply correspond to an initial portion of the heating flow volumes, so that one of the fuel flow and the oxygen-containing flow is added to the general volume of the reactor while the other flow is in separately defined channels.

The separate channels for fuel flow and oxygen-containing flow allow the mixing of the fuel flow and oxygen-containing flow to be deferred until the fuel and oxygen-containing flow reach the mixing zone within the reactor. By delaying the mixing of the fuel flow and oxygen-containing flow, the location of combustion can be controlled. This allows the peak temperature in the reactor to be at a location other than an end of the reactor. The heat from the combustion reaction can then be spread within the reactor by using the combustion products (including any additional unreacted gases present in the fuel flow and oxygen-containing flow) as a heat transport carrier gas. The heat is spread by allowing the heated combustion products to pass from the combustion location into other portions of the reactor via heating flow volumes. The heating flow volumes begin at the combustion location and provide the transport pathway for the combustion products until the combustion products exit from the reactor. At least a portion of the reforming flow channels are surrounded by the heating flow volumes, to allow for heat transfer from the combustion products to the gas flows within the reforming flow channels.

In various embodiments, the flows in the heating flow volumes can be maintained separately from the flows in the reforming flow channels. In some embodiments, this corresponds to maintaining the flows so that the reforming input flow and the reforming product flow are not mixed with the fuel, the oxygen-containing gas, and the oxidized product flow within the reforming flow channels. In such embodiments, for example, a portion of the reforming product flow could still be added to the fuel used for providing heat for the reactor, so long as no portion of the fuel, oxygen-containing gas, or combustion products enters the reforming flow channels. In other embodiments, there is substantially no fluid communication between the reforming flow channels and the heating flow volumes within the reactor that contains the reforming flow channels and the heating flow volumes. In still other embodiments, there is substantially no fluid communication between the reforming flow channels and the heating flow volumes within the reaction system that contains the heating flow volumes and reforming flow channels, such as a reaction system where the heating flow volumes and/or reforming flow channels are present within multiple reactors.

The flows in the heating flow volumes and the reforming flow channels can be maintained as separate flows in any convenient manner. One option is to use manifolds and/or other fluid connections to keep the flow path for the reforming flow channels separate from the fuel flow channels, oxidant flow channels, and heating flow volumes. For example, a manifold can be used to deliver the reactants for reforming to a plurality of tubes (corresponding to reforming flow channels). An additional conduit, an additional group of conduits, and/or an additional manifold feeding an additional group of conduits can be used to deliver either the oxygen-containing flow or the fuel flow to the mixing zone. The remaining flow of the oxygen-containing flow and the fuel flow can then be delivered into the first zone or recuperation zone of the reaction volume. This allows the fuel flow and the oxygen-containing flow to be maintained separately within the first zone or recuperation zone of the reactor volume. The fuel flow and oxygen-containing flow are then allowed to mix in the mixing zone, where combustion occurs. This provides heated combustion products. The combustion location is in fluid communication with the heating flow volumes, which surround the reforming flow channels.

In order to facilitate heat transfer into the reforming flow tubes, the diameter of the reforming flow tubes can be roughly 1.0 cm to 8.0 cm, or 1.0 cm to 6.0 cm, or 1.0 cm to 4.0 cm, or 2.0 cm to 8.0 cm, or 2.0 cm to 6.0 cm. To the degree that flow tubes are used for combustion input flows (such as flow tubes to keep oxidant separate from fuel in the recuperator end of the reactor in order to delay combustion until a middle portion of the reactor), similar tube diameters can be used.

With regard to tube design, the reforming catalyst can be loaded into the tubes in any convenient manner. One option can be to line the interior of the tubes with a refractory material that then serves as a support for reforming catalyst. Another option can be to fill a portion of the catalyst tubes with catalyst particles, such as support particles that have the catalyst supported on the particles. The catalyst particles can be loaded into a tube in any convenient manner for loading catalyst particles, such as dumping, flowing, and/or vacuuming the particles into a tube. The catalyst particles can have any convenient shape, such as rings, trilobes, quadralobes, spheres, or any other convenient shape. The catalyst particles can be added to a tube to form one or more catalyst beds within a tube. Still another option can be to incorporate monoliths into the tubes. Metal tubes with no refractory lining may also be suitable, so long as the metal tubes are suitable for use in the presence of the combustion used for heating the interior of the shell. As an example, when using a monolith, can provide for channels that include a packing with an average wetted surface area per unit volume that ranges from 50 ft⁻¹ to 3000 ft⁻¹ (~0.16 km⁻¹ to ~10 km⁻¹), or from 100 ft⁻¹ to 2500 ft⁻¹ (~0.32 km⁻¹ to ~8.2 km⁻¹), or from 200 ft⁻¹ to 2000 ft⁻¹ (~0.65 km⁻¹ to ~6.5 km⁻¹). The interior channel surfaces of such a monolith can then be coated with a washcoat of reforming catalyst. Regardless of the method for introducing the catalyst, sufficient reforming catalyst can be provided to achieve a gas hourly space velocity between 100 hr⁻¹ and 10,000 hr⁻¹.

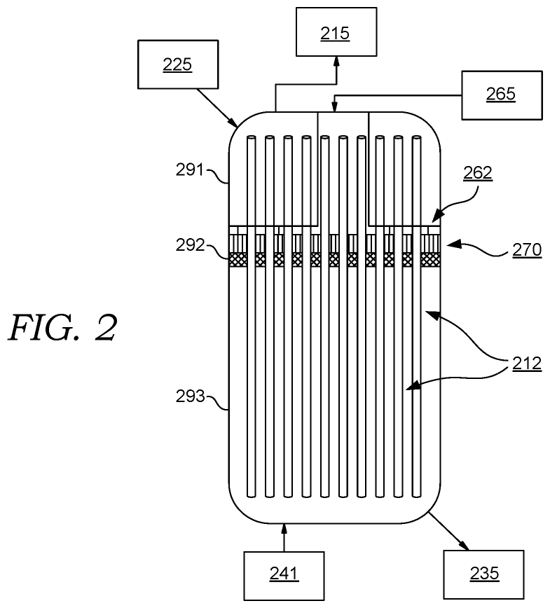

FIG. 2 illustrates an example of a counter-current flow configuration for reforming. In FIG. 2, the reforming reactants 241 and resulting effluent 215 are contained within tubes 212 that correspond to reforming flow channels. The manifold(s) for delivering the reforming reactants 241 to tubes 212 and for recovering the reforming effluent 215 from the tubes 212 are not shown in FIG. 2. One or more mixing structures 270, such as one or more monoliths, are then used to facilitate mixing of the fuel 265 from fuel flow channels 262 with the oxygen-containing flow 225. In the example shown in FIG. 2, the oxygen-containing flow 225 is delivered into the reactor volume without using separate channels within the reactor volume. In the example shown in FIG. 2, the reforming reactants and products travel up through the reactor, while the combustion reactants and products travel down through the reactor. Of course, any other convenient directions of flow for the combustion reactants/products and the reforming reactants/products can be used to create a counter-current flow pattern.

In the configuration shown in FIG. 2, the reforming zone 293, mixing zone 292, and first zone or recuperation zone 291 can be defined based on the location of the mixing structures 270 that provide the mixing. The mixing zone 292 roughly corresponds to the depth of the mixing structures 270. More generally, whatever mixing structures are used to mix the oxygen-containing flow and the fuel flow can correspond to the mixing zone. The first zone or recuperation zone 291 is the portion of the reactor volume above mixing structures 270. The reforming zone 293 is the portion of the reactor volume below mixing structures 270.

During operation, the fuel flow 265 and oxygen-containing flow 225 are introduced into the reactor and combustion is performed at or near the mixing structures 270. As shown in FIG. 2, this is achieved in part by having the fuel flow channels 262 deliver the fuel to a location at or near the top of mixing structures 270. This allows the fuel flow 265 to be maintained separately from oxygen-containing flow 225 as the fuel flow 265 travels to the mixing structures 270. The mixing structures then facilitate mixing of fuel flow 265 and oxygen-containing flow 225, so that combustion occurs. The resulting combustion products then provide heat to the reforming flow channels 212. The combustion products exit from the reactor as flue gas 235.

It is noted that in the configuration shown in FIG. 2, at least the oxygen-containing flow 225 is heated in the first zone or recuperation zone by heat exchange with the reforming products prior to the reforming products 215 exiting from the first zone. This allows for recapture of a portion of the heat remaining in the reforming effluent 215 prior to exiting from the reactor.

After mixing and combustion, the resulting combustion products continue flowing through mixing zone 292 into reforming zone 293, until the combustion products exit from the reactor as flue gas 235. After passing through the mixing structures 270, the combustion products enter into heating flow volume(s) that surround the reforming flow channels (tubes) 212. In the example shown in FIG. 2, the heating flow volume(s) correspond to the portion of the volume of the reactor that surrounds tubes 212 in the reforming zone 293 of the reactor.

One of the benefits of operating with separate reforming flow channels and heating flow volumes is that the environment for the reforming catalyst can be better controlled. In particular, exposure of the nickel-containing reforming catalyst to the combustion reactants and/or products can be reduced, minimized, or eliminated. This reduces or minimizes the potential for the nickel-containing reforming catalyst to be exposed to O₂, thereby minimizing the potential for formation of NiO. NiO is known to be more susceptible to conversion to nickel hydroxide in the presence of steam. Maintaining separate flow channels also avoids the exposure of the nickel-containing reforming catalyst to elevated pressure steam in the combustion products, which would further increase the likelihood of formation of nickel hydroxides.

### Example of Temperature Profile

The example configuration shown in FIG. 2 can also be used to illustrate the temperature profile during operation of the reactor. As shown in FIG. 2, the fuel flow 265 and oxygen-containing flow 225 are not allowed to combine until the flows reach the mixing devices 270. As a result, combustion occurs at or near the mixing devices 270. The location of combustion corresponds to the highest temperature location within the reactor. Thus, the highest temperature location is at or near the mixing zone 292. The exact location of the highest temperature can depend on the flow dynamics within the reactor. Therefore, the highest temperature could be in the middle of mixing zone 292, or it could be near the interface between mixing zone 292 and reforming zone 293, or it could be near the interface between mixing zone 292 and recuperation zone 291.

After combustion occurs, the combustion products plus any diluent in the fuel flow and/or oxygen-containing flow, carry the heat from the combustion reaction downstream in the reactor. This carries heat through the mixing zone and down into reforming zone 293. This provides the heat for performing the reforming reaction. Performing combustion at or near the mixing zone 292 and then carrying the heat downstream using the combustion products results in a temperature profile being set up. The highest temperatures are at or near the mixing zone 292. The temperature then decreases in the reforming zone 293 as the distance from the mixing zone 292 increases. During operation, this allows the reforming reactants to be heated when the reactants first enter the reforming zone 293, with the temperature continuing to increase as the reactants move toward the interface between the reforming zone 293 and the mixing zone 292. This allows the end of the reforming zone 293 that is closest to mixing zone 292 to have the highest temperatures of the reforming zone 293. The catalyst in the reforming flow channels can be arranged so that the catalyst is only included up to the end of the reforming zone 293, meaning that after passing through the maximum temperature point, the amount of additional reforming catalyst that the reforming reactants and products are exposed to is reduced or minimized. The reforming flow then passes through the mixing zone 292 and the recuperation zone 291. In the recuperation zone 291, the oxygen-containing flow can be heated by heat exchange with the reforming products.

Based on the above, a configuration such as the configuration shown in FIG. 2 allows a temperature profile to be set up where the ends of the reactors are colder than a middle location in the reactor. This means that heat exchange can be performed at both ends of the reactor to assist with heating input flows to the reactor.

In various embodiments, by controlling the location of combustion in the counter-current reforming reactor, a temperature profile can be created within the reactor during continuous operation that includes one or more of the following temperature profile features. First, a maximum temperature in the reactor can be located at or near mixing zone 292. Additionally or alternately, a maximum temperature in the reforming zone can be located at or near the interface of mixing zone 292 with reforming zone 293. Depending on the aspect, the maximum temperature in the reactor and/or the maximum temperature in the reforming zone can be 800 °C to 1600 °C, or 800 °C to 1400 °C, or 800 °C to 1200 °C, or 1000 °C to 1600 °C, or 1000 °C to 1400 °C, or 1000 °C to 1200 °C, or 1100 °C to 1600 °C, or 1100 °C to 1400 °C, or 1200 °C to 1600 °C, or 1200 °C to 1400 °C.

The maximum temperature in the reactor and/or the maximum temperature in the reforming zone can be compared with the temperature at various other locations in the reactor. In some embodiments, the maximum temperature in the reactor and/or the maximum temperature in the reforming zone can be higher than the temperature at the end of the reforming zone that is farthest from the mixing zone by 100 °C or more, or 200 °C or more, or 300 °C or more, or 400 °C or more, such as up to 1000 °C or possibly still more. In some embodiments, the maximum temperature in the reactor and/or the maximum temperature in the reforming zone can be higher than the temperature at the end of the recuperation zone that is farthest from the mixing zone by 100 °C or more, or 200 °C or more, or 300 °C or more, or 400 °C or more, such as up to 1000 °C or possibly still more. The location where these temperature are measured can also be specified. For example, when comparing the maximum temperature in the reactor with a temperature at the end of the reforming zone farthest from the mixing zone, the temperature in the reforming zone can be characterized either in the heating flow volumes (where the flue gas from combustion is) or in the reforming flow channels (where the reforming reactants are being heated by heat exchange with the combustion flue gas). Similarly, when comparing with a temperature in the recuperation zone, the temperature can be specified in the volume where the oxygen-containing gas is, in the volume where the fuel flow is, or in the reforming flow channels where the reforming products are exiting from the reactor.

In some embodiments, the temperature in the reforming zone at the end farthest from the mixing zone can be 300 °C to 700 °C, or 400 °C to 700 °C, or 500 °C to 700 °C, or 300 °C to 600 °C, or 400 °C to 600 °C, or 300 °C to 500 °C. Optionally, the input flow of reforming reactants into the reforming flow channels at the end of the reforming zone can be at a colder temperature, so that the reforming reactants are heated by heat exchange with the combustion flue gas that is exiting from the heating flow volumes in the reforming zone. In such optional embodiments, the temperature of the reforming reactants entering the reforming flow channels in the reforming zone can be 250 °C to 500 °C, or 350 °C to 500 °C, or 250 °C to 400 °C.

In some embodiments, the temperature in the recuperation zone at the end farthest from the mixing zone can be 300 °C to 700 °C, or 400 °C to 700 °C, or 500 °C to 700 °C, or 300 °C to 600 °C, or 400 °C to 600 °C, or 300 °C to 500 °C. Optionally, the input flow of combustion reactants (oxygen-containing gas and/or fuel) into the reactor at the end of the reforming zone can be at a colder temperature, so that the combustion reactants are heated by heat exchange with the combustion flue gas that is exiting from the heating flow volumes in the reforming zone. In such optional embodiments, the temperature of the combustion reactants entering the reforming flow channels in the reforming zone can be 200 °C to 500 °C, or 300 °C to 500 °C, or 200 °C to 400 °C.

In addition to temperature, the pressure and space velocity for the reforming reaction can be specified. The reaction conditions for reforming hydrocarbons can include a pressure of 0 psig to 1500 psig (10.3 MPa), or 0 psig to 1000 psig (6.9 MPa), or 0 psig to 550 psig (3.8 MPa); and a gas hourly space velocity of reforming reactants of 100 hr⁻¹ to 10,000 hr⁻¹. The space velocity corresponds to the weight of reactants relative to the weight of reforming catalyst per unit time.

The reforming reaction is performed in the presence of an Ni-containing catalyst. In some embodiments, the catalyst can correspond to Ni. In other embodiments, a mixture of catalytic metals can be used and/or a catalyst system can be used with different metals in different locations. For example, a first portion of the catalyst could be Ni while a second portion of the catalyst could be a mixture of Ni and Rh. As another example, a first portion of the catalyst could be Ni, a second portion could be a mixture of Ni and Rh, and a third portion could be Rh. These portions can be in different locations within the reforming flow channels, so that the reforming input flow is exposed sequentially to each catalyst portion. In other words, when multiple catalyst portions are present, the catalyst portions can be arranged so that the catalyst portions are upstream and/or downstream from the other catalyst portions present in the reforming flow channels.

Suitable catalytic metals can include, but are not limited to, Ni, Rh, Ru, Pd, Pt, Ir, Cu, Co, or a combination of thereof.

### Additional Configuration Examples

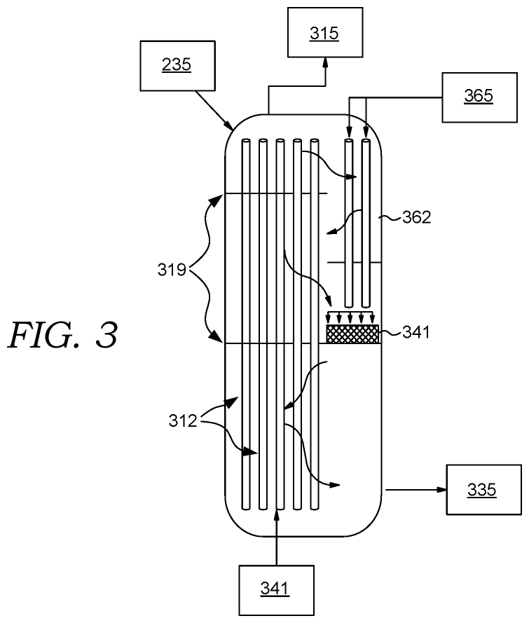

FIG. 3 shows another example of a counter-current flow configuration for reforming. In the example configuration shown in FIG. 3, the combustion location is physically offset from portion of the reactor where the reforming flow channels are located.

In the configuration shown in FIG. 3, fuel flow 365 is introduced into fuel flow channels 362. This allows the fuel flow 365 to be maintained in separate volumes from oxygen-containing flow 325 until the fuel flow and oxygen-containing flow reach mixing devices 370. Within the reactor, a series of baffles 319 are used to form a flow path for oxygen-containing flow 325. This allows the oxygen-containing flow 325 to be heated (prior to combustion) by heat exchange with the reforming products in reforming flow channels 312.

As shown in FIG. 3, the mixing devices 370 are offset within the reactor from the reforming flow channels 312. When combustion occurs, the highest temperatures are present at mixing devices 370. The combustion gases carry this heat back toward the reforming flow channels 312, where heat exchange is used to provide heat for the reforming reaction. The combustion products then exit the reactor as flue gas 335. The configuration in FIG. 3 avoids exposing the reforming tubes directly to combustion temperatures while still allowing a single counter-current flow scheme to be used to provide heat for the reforming reaction in the reforming flow channels 312.

The heat generated by the combustion reaction is used to heat the reforming flow channels 312. In part due to the flow pattern set up by the baffles, after combustion, the combustion products are passed back toward the reforming flow channels 312 in the reforming zone 393. In the configuration shown in FIG. 3, the reforming reactants 341 are passed into reforming flow channels 312. This results in formation of reforming products 315. The reforming flow channels allow the reforming reactants and products to stay separate from the reactants and products for the combustion reaction.

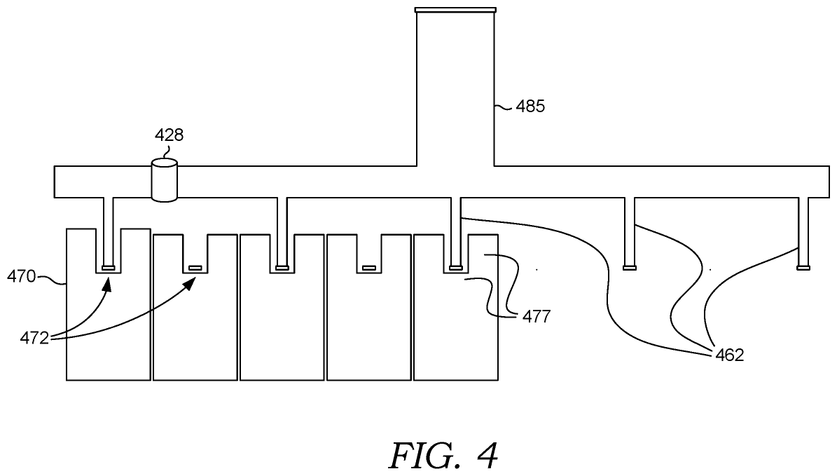

FIG. 4 shows an example of how a fuel flow and an oxygen-containing flow can be mixed at mixing devices. In FIG. 4, a fuel flow is delivered to surfaces 477 of mixing devices 470 using fuel flow channels 462. The mixing devices 470 can correspond to any convenient type of mixing device. In the example shown in FIG. 4, mixing devices 470 correspond to monolith structures with channels in the monoliths, but other types of mixing devices can be used. The fuel flow is delivered to the surfaces 477 of mixing devices 470 using fuel flow channels 462. In the example shown in FIG. 4, the fuel flow exits from fuel flow channels 462 in indentations 472 in the mixing devices 470. In the example shown in FIG. 4, the fuel flow channels 462 above the mixing devices 470 correspond to a manifold structure 485 that distributes the fuel flow into the indentations 472. Through holes 428 are provided in manifold structure 485 to allow the oxygen-containing flow 425 to reach the surface of the mixing devices 470. This type of configuration allows the oxygen and fuel to mix so that combustion occurs at or near the mixing devices 470. The combustion products can then carry the heat generated by combustion downstream to the reforming flow channels.

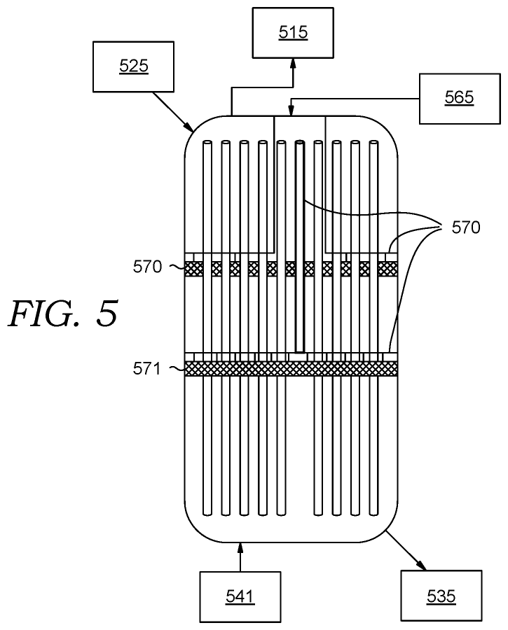

FIG. 5 shows yet another example of a configuration for heating the reforming flow channels while maintaining the combustion products in separate heating flow volumes. In the configuration shown in FIG. 5, a portion of the fuel flow channels are used to deliver fuel into the reforming zone of the reactor, so that a first portion of the combustion reaction takes place at a first location within the reactor, while a remaining portion of the combustion reaction takes place at a downstream location. This provides further distribution of heat within the reactor by performing a portion of the combustion at a downstream location within the reforming zone. But the heating concept is otherwise similar to the configuration shown in FIG. 2. The combustion of oxygen-containing gas 525 and fuel 565 provides heat for converting the reforming input flow 541 into reforming products 515. The combustion products are exhausted as flue gas 535.

In FIG. 5, two sets of mixing devices 570 and 571 are present. The fuel flow channels 562 deliver a portion of fuel flow 565 to the first mixing device 570, while a remaining portion of the fuel flow 565 is delivered to the second mixing device 571.

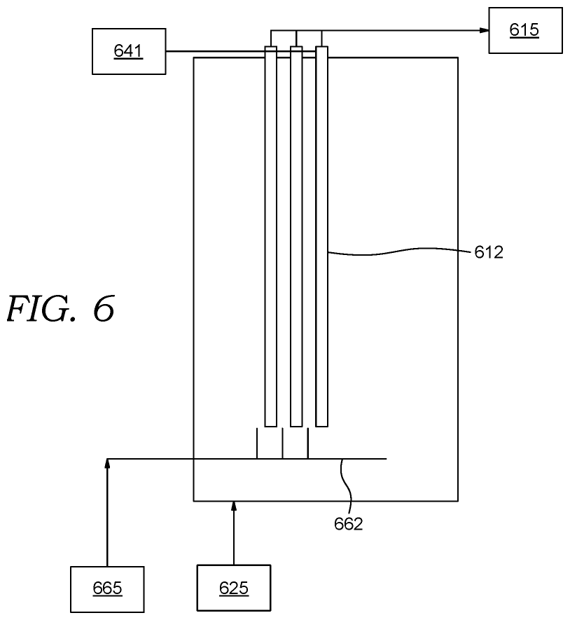

FIG. 6 schematically shows another configuration example. In this example, the flow of the combustion reactants and products is substantially counter-current to the flow of the reforming reactants and reforming products during the reforming reaction. However, the reforming products do not exit from the reactor at the opposing end. Instead, in the configuration shown in FIG. 6, bayonet tubes are used to allow the reforming products to exit from the same end of the reactor where the reforming reactants entered.

In FIG. 6, the fuel flow 665 and oxygen-containing flow 625 enter from the bottom of the reactor. In the example shown in FIG. 6 the fuel flow exits from the fuel flow tubes 662 at roughly the turn-around or end point for the reforming flow tubes 612.

For the reforming flow tubes 612, the reforming reactants 641 enter at the top of the reactor. The reforming flow tubes have an outer annular volume and an inner return volume. When the reforming reactants 641 enter the reforming flow tubes 612, the reforming reactants pass into the outer annular volume. This outer annular volume is where the substantial majority of the reforming catalyst is (such as up to all of the reforming catalyst). During operation, the heat from the combustion reaction is transferred to the outer annular volume, allowing the reforming reaction to occur in the presence of the reforming catalyst. The reforming products then return to the top in the inner return volume before exiting as reforming effluent 615. This allows the reforming products to provide additional heating for the reforming reactants near the top of the reactor.

In the configuration shown in FIG. 6, the configuration is substantially counter-current, even though both the combustion product and the reforming products exit from the top of the reactor. This is because the reforming occurs in the outer annular volume, so that when reforming is occurring, the reforming flow is counter-current to the combustion flow. While some reforming catalyst could be included in the inner volume, due to the lower temperatures in the inner volume, any substantial exposure to reforming catalyst would tend to result in loss of reforming products due to the reversibility of the reforming reaction. So even if some reforming catalyst is located in the inner volume that serves as the return flow path, the substantial majority of the reforming occurs in the outer annular volume, leading to a substantially counter-current configuration for combustion relative to reforming.

### Process Example—Reforming and Heating

In various embodiments, reforming of hydrocarbons can be performed under steam reforming conditions in the presence of H₂O, under dry reforming conditions in the presence of CO₂, or under conditions where both H₂O and CO₂ are present in the reaction environment. As a general overview of operation of reforming in a counter-current reactor, the heat for performing the reforming reaction is provided by performing heating in heating flow tubes or a heating flow volume. The heat is provided, for example, by performing combustion at a combustion location with the heating flow tubes or heating flow volume. The heat from combustion is then carried downstream in the heating flow tubes or heating flow volume by the gas flow of combustion products and/or any carrier gases (such as N₂) that are present in the combustion input flow. Reforming can then occur within the reforming flow tubes, with the reforming reaction consuming heat provided by the heating flow tubes and/or heating volume.

The reforming reaction performed within the reactor can correspond reforming of methane and/or other hydrocarbons using steam reforming, in the presence of H₂O; using dry reforming, in the presence of CO₂, or using “bi” reforming in the presence of both H₂O and CO₂. Examples of stoichiometry for steam, dry, and “bi” reforming of methane are shown in equations (1)-(3).

Dry Reforming: CH₄+CO₂=2CO+2H₂ (1)

Steam Reforming: CH₄+H₂O=CO+3H₂ (2)

Bi Reforming: 3CH₄+2H₂O+CO₂=4CO+8H₂. (3)

As shown in equations (1)-(3), dry reforming can produce lower ratios of H₂ to CO than steam reforming. Reforming reactions performed with only steam can generally produce a ratio of H₂ to CO of around 3, such as 2.5 to 3.5. By contrast, reforming reactions performed in the presence of CO₂ can generate much lower ratios, possibly approaching a ratio of H₂ to CO of roughly 1.0 or even lower. By using a combination of CO₂ and H₂O during reforming, the reforming reaction can potentially be controlled to generate a wide variety of H₂ to CO ratios in a resulting syngas.

It is noted that the ratio of H₂ to CO in a synthesis gas can also be dependent on the water gas shift equilibrium. Although the above stoichiometry shows ratios of roughly 1 or roughly 3 for dry reforming and steam reforming, respectively, the equilibrium amounts of H₂ and CO in a synthesis gas can be different from the reaction stoichiometry. The equilibrium amounts can be determined based on the water gas shift equilibrium, which relates the concentrations of H₂, CO, CO₂ and H₂O based on the reaction

H₂O+CO<=>H₂+CO₂ (4)

Most reforming catalysts, such as rhodium and/or nickel, can also serve as water gas shift catalysts. Thus, if reaction environment for producing H₂ and CO also includes H₂O and/or CO₂, the initial stoichiometry from the reforming reaction may be altered based on the water gas shift equilibrium. This equilibrium is also temperature dependent, with higher temperatures favoring production of CO and H₂O. It is noted that higher temperatures can also improve the rate for reaching equilibrium. As a result, the ability to perform a reforming reaction at elevated temperatures can potentially provide several benefits. For example, instead of performing steam reforming in an environment with excess H₂O, CO₂ can be added to the reaction environment. This can allow for both a reduction in the ratio of H₂ to CO produced based on the dry reforming stoichiometry as well as a reduction in the ratio of H₂ to CO produced based on the water gas shift equilibrium. Alternatively, if a higher H₂ to CO ratio is desired, CO₂ can be removed from the environment, and the ratio of H₂O to CH₄ (or other hydrocarbons) can be controlled to produce a desirable type of synthesis gas. This can potentially allow for generation of a synthesis gas having a H₂ to CO ratio of 0.1 to 15, or 0.1 to 3.0, or 0.5 to 5.0, or 1.0 to 10, by selecting appropriate amounts of feed components.

One common source for methane is natural gas. In some applications, natural gas, including associated hydrocarbon and impurity gases, may be used as a feed for the reforming reaction. The supplied natural gas also may be sweetened and/or dehydrated natural gas. Natural gas commonly includes various concentrations of associated gases, such as ethane and other alkanes, preferably in lesser concentrations than methane. The supplied natural gas may include impurities, such as H₂S and nitrogen. More generally, the hydrocarbon feed for reforming can include any convenient combination of methane and/or other hydrocarbons. Optionally, the reforming feed may also include some hydrocarbonaceous compounds, such as alcohols or mercaptans, which are similar to hydrocarbons but include one or more heteroatoms different from carbon and hydrogen. In some embodiments, an additional component present in the feed can correspond to impurities such as sulfur that can adsorb to the catalytic monolith during a reducing cycle (such as a reforming cycle). Such impurities can be oxidized in a subsequent cycle to form sulfur oxides, which can then be reduced to release additional sulfur-containing components (or other impurity-containing components) into the reaction environment.

In some embodiments, the feed for reforming can include, relative to a total weight of hydrocarbons in the feed for reforming, 5 wt % or more of C₂₊ compounds, such as ethane or propane, or 10 wt % or more, or 15 wt % or more, or 20 wt % or more, such as up to 50 wt % or possibly still higher. It is noted that nitrogen and/or other gases that are non-reactive in a combustion environment, such as H₂O and CO₂, may also be present in the feed for reforming. In embodiments where the reformer corresponds to an on-board reforming environment, such non-reactive products can optionally be introduced into the feed, for example, based on recycle of an exhaust gas into the reformer. Additionally or alternately, the feed for reforming can include 40 wt % or more methane, or 60 wt % or more, or 80 wt % or more, or 95 wt % or more, such as having a feed that is substantially composed of methane (98 wt % or more). In embodiments where the reforming corresponds to steam reforming, a molar ratio of steam molecules to carbon atoms in the feed can be 0.3 to 4.0. It is noted that methane has 1 carbon atom per molecule while ethane has 2 carbon atoms per molecule. In embodiments where the reforming corresponds to dry reforming, a molar ratio of CO₂ molecules to carbon atoms in the feed can be 0.05 to 3.0.

### Additional Embodiments

Embodiment 1. A method for performing reforming under substantially counter-current flow conditions in a reaction system comprising a first reactor zone, a mixing zone, and a reforming zone, comprising: passing a fuel into a fuel flow path and an oxygen-containing gas into an oxidant flow path in the first reactor zone, the oxygen-containing gas comprising 15 vol % or less of N₂ relative to a volume of the oxygen-containing gas; passing a reforming input flow comprising at least one hydrocarbon into a plurality of reforming flow channels in the reforming zone, at least a portion of the reforming flow channels comprising a reforming catalyst containing Ni in the reforming zone; mixing the fuel, the oxygen-containing gas, and a recycle stream containing H₂ and CO₂ in one or more heating flow volumes within a mixing zone to form a fuel mixture comprising 20 vol % or more of CO₂ relative to a volume of the fuel mixture, the mixing zone being adjacent to the first zone, an opposing side of the mixing zone being adjacent to the reforming zone; combusting the fuel mixture in the one or more heating flow volumes in at least one of the mixing zone and the reforming zone to generate heat and a combustion product flow, the one or more heating flow volumes being arranged around the plurality of reforming flow channels in the mixing zone and the reforming zone, a direction of flow for the reforming input flow in the portion of the reforming channels comprising the reforming catalyst being substantially counter-current to a direction of flow for the combustion product flow; reforming at least a portion of the at least one hydrocarbon in the reforming channels under reforming conditions in the presence of the reforming catalyst to form a reforming product flow, a peak temperature in the reforming flow channels being greater than a temperature in the reforming flow channels at an end of the reforming zone farthest from the mixing zone by 100 °C or more; separating the combustion product flow to form a CO₂-containing product stream and a first recycle portion; and separating the reforming product flow to form an H₂-containing product stream comprising 80 vol % or more of H₂ and second recycle portion containing H₂, wherein the recycle stream comprises the first recycle portion and the second recycle portion, wherein the reforming input flow and the reforming product flow are not mixed with the fuel, the oxygen-containing gas, and the oxidized product flow within the reforming flow channels, and optionally wherein the first zone, the mixing zone, and the reforming zone are part of a single reactor volume.

Embodiment 2. The method of Embodiment 1, wherein the reforming flow channels are substantially free of fluid communication with the heating flow volumes; or wherein reforming the at least a portion of the at least one hydrocarbon comprises reforming without exposing a portion of the fuel, a portion of the oxygen-containing gas, or a portion of the combustion product flow to the reforming conditions; or a combination thereof.

Embodiment 3. The method of any of the above embodiments, wherein the combusting is performed in a first heating flow volume and wherein a second heating flow volume is arranged around the reforming flow channels, the combustion product flow passing from the first heating flow volume to the second heating flow volume after the combusting.

Embodiment 4. The method of any of the above embodiments, wherein the first zone is a recuperation zone, and wherein a flow direction in the reforming flow channels is substantially counter-current to a flow direction of the combustion product flow for substantially the entire length of the reforming flow channels, or wherein the reforming product flow is exhausted from the first zone, or a combination thereof.

Embodiment 5. The method of any of the above embodiments, wherein a peak temperature in the one or more heating flow volumes is greater than a temperature in the fuel flow path at an end of the first zone farthest from the mixing zone by 200 °C or more; or wherein a peak temperature in the one or more heating flow volumes is greater than a temperature in the one or more heating flow volumes at an end of the reforming zone farthest from the mixing zone by 200 °C or more; or a combination thereof.

Embodiment 6. The method of any of any of the above embodiments, wherein the reforming product flow is exhausted from the reforming zone, and wherein a peak temperature in the reforming flow channels is greater than a temperature in the fuel flow path at an end of the first zone that is farthest from the mixing zone by 200 °C or more.

Embodiment 7. The method of any of the above embodiments, wherein the reforming catalyst that contains Ni further comprises Rh.

Embodiment 8. The method of Embodiment 7, wherein the reforming catalyst comprises a first reforming catalyst portion that comprises Ni, a second reforming catalyst portion that comprises a mixture of Rh and Ni, and optionally a third reforming catalyst portion that comprises Rh, the first reforming catalyst portion optionally being upstream from the second reforming catalyst portion relative to a direction of flow during reforming of the at least one hydrocarbon in the presence of the first reforming catalyst portion and the second reforming catalyst portion.

Embodiment 9. The method of any of the above embodiments, wherein the second recycle portion is passed into the one or more heating flow volumes by passing the second recycle portion into the fuel flow path, or wherein the first recycle portion is passed into the one or more heating flow volumes by passing the first recycle portion into the oxidant flow path, or a combination thereof.

Embodiment 10. The method of any of the above embodiments, wherein the fuel mixture is combusted at a pressure of 0.7 MPa−g or higher, or 3.4 MPa−g or higher; or wherein the CO₂-containing product stream is at a pressure of 0.7 MPa−g or higher, or 3.4 MPa−g or higher; or a combination thereof.

Embodiment 11. The method any of the above embodiments, the oxidant flow path comprises a portion of the reactor volume within the first zone, and the fuel flow path comprises one or more conduits providing fluid communication between an end of the first zone and the mixing zone.

Embodiment 12. A reforming reaction system, comprising: a reactor having a reactor volume comprising a first zone, one or more mixing elements in a mixing zone, a reforming zone, one or more reforming flow channels, and one or more heating flow volumes, at least a portion of the one or more reforming flow channels residing in the reforming zone and comprising a reforming catalyst that contains Ni, the mixing zone being adjacent to the first zone, an opposing side of the mixing zone being adjacent to the reforming zone, the one or more second flow channels being arranged around the one or more reforming flow channels, wherein the first zone comprises at least an oxidant flow path and a fuel flow path, at least one of the fuel flow path and the oxidant flow path providing fluid communication between an end of the first zone and the mixing zone without providing fluid communication between the oxidant flow path and the fuel flow path in the first zone; a first separation stage comprising a first separation inlet in fluid communication with the one or more heating flow volumes and a plurality of first separation outlets, at least one first separation outlet in fluid communication with the oxidant flow path; a second separation stage comprising a second separation inlet in fluid communication with the one or more reforming channels and a plurality of second separation outlets, at least one second separation outlet in fluid communication with the fuel flow path; and wherein the one or more reforming flow channels and the one or more heating flow volumes do not have direct fluid communication within the reactor volume.

Embodiment 13. The reactor of Embodiment 12, wherein the one or more reforming flow channels are substantially free of fluid communication with the one or more heating flow volumes.

Embodiment 14. The reactor of Embodiment 12 or 13, a) wherein the reaction system further comprises at least one conduit exiting from the first zone that provides the fluid communication between the one or more reforming channels and the plurality of second separation outlets the reforming product flow is exhausted from the first zone; or b) wherein the reaction system further comprises at least one conduit exiting from the reforming zone that provides the fluid communication between the one or more reforming channels and the plurality of second separation outlets the reforming product flow is exhausted from the first zone.

Embodiment 15. The reactor of any of Embodiments 12 to 14, wherein the reforming catalyst comprises a first reforming catalyst portion that comprises Ni, a second reforming catalyst portion that comprises a mixture of Rh and Ni, and optionally a third reforming catalyst portion that comprises Rh.

Additional Embodiment A. The method of any of Embodiments 1 to 11, further comprising separating air in an air separation unit to form the oxygen-containing gas.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

1. A method for performing reforming under substantially counter-current flow conditions in a reaction system comprising a first reactor zone, a mixing zone, and a reforming zone, comprising:
passing a fuel into a fuel flow path and an oxygen-containing gas into an oxidant flow path in the first reactor zone, the oxygen-containing gas comprising 15 vol % or less of N₂ relative to a volume of the oxygen-containing gas;
passing a reforming input flow comprising at least one hydrocarbon into a plurality of reforming flow channels in the reforming zone, at least a portion of the reforming flow channels comprising a reforming catalyst containing Ni in the reforming zone;
mixing the fuel, the oxygen-containing gas, and a recycle stream containing H₂ and CO₂ in one or more heating flow volumes within a mixing zone to form a fuel mixture comprising 20 vol % or more of CO₂ relative to a volume of the fuel mixture, the mixing zone being adjacent to the first zone, an opposing side of the mixing zone being adjacent to the reforming zone;
combusting the fuel mixture in the one or more heating flow volumes in at least one of the mixing zone and the reforming zone to generate heat and a combustion product flow, the one or more heating flow volumes being arranged around the plurality of reforming flow channels in the mixing zone and the reforming zone, a direction of flow for the reforming input flow in the portion of the reforming channels comprising the reforming catalyst being substantially counter-current to a direction of flow for the combustion product flow;
reforming at least a portion of the at least one hydrocarbon in the reforming channels under reforming conditions in the presence of the reforming catalyst to form a reforming product flow, a peak temperature in the reforming flow channels being greater than a temperature in the reforming flow channels at an end of the reforming zone farthest from the mixing zone by 100 °C or more;
separating the combustion product flow to form a CO₂-containing product stream and a first recycle portion; and
separating the reforming product flow to form an H₂-containing product stream comprising 80 vol % or more of H₂ and second recycle portion containing H₂,
wherein the recycle stream comprises the first recycle portion and the second recycle portion, and
wherein the reforming input flow and the reforming product flow are not mixed with the fuel, the oxygen-containing gas, and the oxidized product flow within the reforming flow channels.

2. The method of claim 1, wherein the reforming flow channels are substantially free of fluid communication with the heating flow volumes.

3. The method of claim 1, wherein the combusting is performed in a first heating flow volume and wherein a second heating flow volume is arranged around the reforming flow channels, the combustion product flow passing from the first heating flow volume to the second heating flow volume after the combusting.

4. The method of claim 1, wherein the first zone is a recuperation zone, and wherein a flow direction in the reforming flow channels is substantially counter-current to a flow direction of the combustion product flow for substantially the entire length of the reforming flow channels.

5. The method of claim 1, wherein the reforming product flow is exhausted from the first zone.

6. The method of claim 1, wherein the reforming product flow is exhausted from the reforming zone.

7. The method of claim 6, wherein a peak temperature in the reforming flow channels is greater than a temperature in the fuel flow path at an end of the first zone that is farthest from the mixing zone by 200 °C or more.

8. The method of claim 1, wherein the reforming catalyst that contains Ni further comprises Rh.

9. The method of claim 8, wherein the reforming catalyst comprises a first reforming catalyst portion that comprises Ni, a second reforming catalyst portion that comprises a mixture of Rh and Ni, and optionally a third reforming catalyst portion that comprises Rh.

10. The method of claim 9, wherein the first reforming catalyst portion is upstream from the second reforming catalyst portion relative to a direction of flow during reforming of the at least one hydrocarbon in the presence of the first reforming catalyst portion and the second reforming catalyst portion.

11. The method of claim 1, wherein the second recycle portion is passed into the one or more heating flow volumes by passing the second recycle portion into the fuel flow path, or wherein the first recycle portion is passed into the one or more heating flow volumes by passing the first recycle portion into the oxidant flow path, or a combination thereof.

12. The method of claim 1, wherein the fuel mixture is combusted at a pressure of 0.7 MPa−g or higher, or wherein the CO₂-containing product stream is at a pressure of 0.7 MPa−g or higher, or a combination thereof.

13. The method of claim 1, wherein the fuel mixture is combusted at a pressure of 3.4 MPa−g or higher, or wherein the CO₂-containing product stream is at a pressure of 3.4 MPa−g or higher, or a combination thereof.

14. The method of claim 1, wherein a peak temperature in the one or more heating flow volumes is greater than a temperature in the fuel flow path at an end of the first zone farthest from the mixing zone by 200 °C or more.

15. The method of claim 1, wherein a peak temperature in the one or more heating flow volumes is greater than a temperature in the one or more heating flow volumes at an end of the reforming zone farthest from the mixing zone by 200 °C or more.

16. The method of claim 1, wherein the first zone, the mixing zone, and the reforming zone are part of a single reactor volume.

17. The method of claim 1, the oxidant flow path comprises a portion of the reactor volume within the first zone, and the fuel flow path comprises one or more conduits providing fluid communication between an end of the first zone and the mixing zone.

18. The method of claim 1, wherein reforming the at least a portion of the at least one hydrocarbon comprises reforming without exposing a portion of the fuel, a portion of the oxygen-containing gas, or a portion of the combustion product flow to the reforming conditions.

19. The method of claim 1, further comprising separating air in an air separation unit to form the oxygen-containing gas.

20. A reforming reaction system, comprising:
a reactor having a reactor volume comprising a first zone, one or more mixing elements in a mixing zone, a reforming zone, one or more reforming flow channels, and one or more heating flow volumes, at least a portion of the one or more reforming flow channels residing in the reforming zone and comprising a reforming catalyst that contains Ni, the mixing zone being adjacent to the first zone, an opposing side of the mixing zone being adjacent to the reforming zone, the one or more second flow channels being arranged around the one or more reforming flow channels,
wherein the first zone comprises at least an oxidant flow path and a fuel flow path, at least one of the fuel flow path and the oxidant flow path providing fluid communication between an end of the first zone and the mixing zone without providing fluid communication between the oxidant flow path and the fuel flow path in the first zone;
a first separation stage comprising a first separation inlet in fluid communication with the one or more heating flow volumes and a plurality of first separation outlets, at least one first separation outlet in fluid communication with the oxidant flow path;
a second separation stage comprising a second separation inlet in fluid communication with the one or more reforming channels and a plurality of second separation outlets, at least one second separation outlet in fluid communication with the fuel flow path; and
wherein the one or more reforming flow channels and the one or more heating flow volumes do not have direct fluid communication within the reactor volume.

21. The reactor of claim 20, wherein the one or more reforming flow channels are substantially free of fluid communication with the one or more heating flow volumes.

22. The reactor of claim 20, wherein the reaction system further comprises at least one conduit exiting from the first zone that provides the fluid communication between the one or more reforming channels and the plurality of second separation outlets the reforming product flow is exhausted from the first zone.

23. The reactor of claim 20, wherein the reaction system further comprises at least one conduit exiting from the reforming zone that provides the fluid communication between the one or more reforming channels and the plurality of second separation outlets the reforming product flow is exhausted from the first zone.

24. The reactor of claim 20, wherein the reforming catalyst comprises a first reforming catalyst portion that comprises Ni, a second reforming catalyst portion that comprises a mixture of Rh and Ni, and optionally a third reforming catalyst portion that comprises Rh.
